(19) United States
(12) Patent Application Publication
(10) Pub. No.: US 2009/0107974 A1
(43) Pub. Date: Apr. 30, 2009

(54) Heating element for an internal combustion engine

(76) Inventor: Matthew Testa, New Hartford, NY (US)

Correspondence Address: BERNHARD P. MOLLDREM, JR., 224 HARRISON STREET, SUITE 200, SYRACUSE, NY, 13202, US

(21) Appl. No.: 11/978,023

(22) Filed: Oct. 29, 2007

(51) Int. Cl. H05B 3/02; F02N 17/04

(52) U.S. Cl. 219/208; 123/142.5 E; 392/485

(57) ABSTRACT

The present invention provides a method and apparatus to quickly raise the temperature of an internal combustion engine and the temperature of the ambient air in a passenger compartment of a vehicle. The apparatus comprises a heating element that quickly realizes a temperature of approximately 300 degrees F. Heating system fluid flows across this heating element which raises the temperature of the heating system fluid. This now heated heating system fluid flows through heater core tubes which are connected to heater core fins, thus raising the ambient temperature air which is blown over the heater core fins and into the passenger compartment. The heated heating system fluid also flows over the engine thus helping to raise the operating temperature of the engine.

### FIELD OF THE INVENTION

The present invention relates generally to the field of automobiles and, more particularly, to a heating element which assists in heating automobile components of an internal combustion engine and forced air at start up.

### BACKGROUND OF THE INVENTION

Automobiles use a cooling system to help maintain engine temperature and to regulate open and closed loop emission systems. For emission systems to become effective the engine must be up to temperature. The emission system regulates unwanted gases from the motor and through an exhaust system. Some emission include carbon monoxide, carbon dioxide, hydrocarbons and oxides of nitrogen. Engines use many different sensors and a control system to force an engine into a closed loop system.

The sensors include oxygen sensors for monitoring exhaust temperature and oxygen content; ECT sensor for monitoring the engine coolant temperature; manifold pressure sensor for measuring the engine vacuum within the motor. Until the engine reaches a closed loop these sensors cannot help to control the emissions.

Automobiles use antifreeze to help maintain engine temperatures. The radiator, water pump, thermostat, heater core, cooling fans and coolant reservoir comprise the typical temperature maintenance system.

The motor typically takes about five to eight minutes to come up to operating temperature. The heated motor raises the temperature of the coolant as it flows over the motor.

The hot coolant from the motor flows through the heater core, which raises the temperature of the heater core. Air blown over heater core fins dissipate the heat to the blown air. Then heated air is then blown through tubes and vents to the automobile passenger compartment. Until the coolant temperature is up to the engine operating temperature (typically 180-220° F.) you will have little or no heat within the vehicle passenger compartment.

In colder climates throughout the world many people have a difficult time in bringing their automobiles up to operating temperature during the winter months. In extreme climates, automobile owners must actually connect a warming element to their vehicles during extended shut-down periods, such as overnite, to avoid cracking the engine block during warming to avoid freezing and shut down of starting components.

Furthermore, in these extreme climates it is often necessary to use a block heater or warming blanket which are connected to 110 v to keep the engine warm so that it will even start the overnite.

It is also uncomfortable to drive a vehicle that forces cold air through its heating system during the winter months. The driver typically waits for the vehicle to warm up to proceed.

Further, to prolong engine components it is desirable to bring the engine temperature up to a warm temperature so that the engine oil realizes improved viscosity so that the pistons move with ease through its up and down cycles. When the oil is still cold, the piston struggles to move up and down thus causing unwanted deformed strokes, which shortens the life of the engine.

In less extreme climates automobile owners still must endure significant time periods of engine and air warming before travel during the colder months. Many people have remote starters which allows the driver to start and warm the vehicle prior to travel. One problem with this is that remote starter are often unreliable thereby forcing the driver to walk to his vehicle, start the vehicle, return to the house and still wait for the vehicle to warm.

Remote starters often cause severe electrical problems to the automobile after prolonged use. To install a remote starter the vehicle wiring harness is typically completely cut and reinstalled. As a wire corrodes from exposure after being cut, costly electrical problems quickly arise.

Another problem with allowing a vehicle to achieve operating temperature is that a significant amount of fuel is wasted. Wasting fuel not only costs money, but it releases unnecessary pollutants into the environment, thus contributing to global warming.

### SUMMARY AND OBJECTS OF THE PRESENT INVENTION

It is an object of the present invention to improve the automobile industry.

It is a further object of the present invention to improve the art of heating automobiles.

It is another object of the present invention to prevent pollutants from being unnecessarily released into the environment.

It is yet a further object of the present invention to save automobile users money by decreasing the amount of fuel required to bring an automobile up to operating temperature.

These and other objects are provide in accordance with the present invention in which there is provided a heating system fluid heater for an internal combustion engine in which heating system fluid stores and dissipates heat within the internal combustion engine heating system. The heating system fluid heater includes an electrically conductive heating element which contacts the heating system fluid thereby raising its temperature. The electrically conductive heating is connected across an internal combustion engine battery. Switching means are provided for to make and break the electrical connection.

In a preferred embodiment the heating system fluid heater includes a housing which has an inlet opening for receiving heating system fluid therethrough from a first end of a transected heating system hose. The housing also includes an outlet opening disposed within said housing for transmitting heating system fluid through a second end of the transected heating system hose. Finally, the housing includes a heating element opening through which the electrically conductive heating element is disposed.

Typically, the heating element is a metallic tubular member. To raise the temperature of the passenger compartment quicker, the second end of the transected hose feeds an inlet opening to a heater core of the internal combustion engine heating system.

In alternative embodiments the heating element may disposed in various components of the heating system such as an engine housing, a radiator housing, a heater core housing, a water pump housing, a heating system fluid reservoir housing and a heating system hose.

In yet another alternative embodiment, the heating element may be freestanding and externally connected with the heating system fluid. In this embodiment a coiled tube containing heating system fluid is wound about the heating element so that heat is transferred indirectly to the system fluid via the coiled tube.

### BRIEF DESCRIPTION OF THE DRAWINGS

The present invention will be understood and appreciated more fully from the following detailed description taken in conjunction with the drawings in which:

FIG. 1 is a side elevation view of an internal combustion engine heating system of the prior art;

FIG. 2 is a side elevation view of the internal combustion engine of FIG. 1 in accordance with a preferred embodiment of the present invention;

FIG. 3 is a cross sectional view of a heating element in accordance with a preferred embodiment of the present invention;

FIG. 4 is a perspective view of the heating element of FIG. 3 freestanding without a housing and connected to the internal combustion engine battery;

FIG. 5 is an alternative housing in accordance with a preferred embodiment containing the heating element of FIG. 3;

FIG. 6 is an alternative embodiment in which the heating element is directly installed into an engine block; and

FIG. 7 is another alternative embodiment in which the heating element is freestanding and wound about by a coil having heating system fluid therein.

### DETAILED DESCRIPTION OF THE PRESENT INVENTION

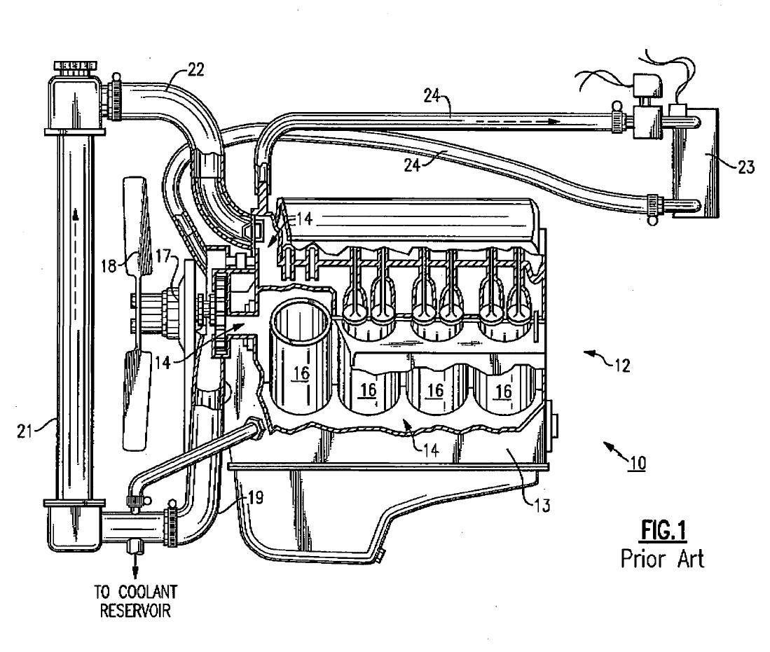

Referring now to FIG. 1, there is shown a heating system 10 for a fluid cooled internal combustion engine 12. The engine 12 includes a block 13 having a jacket, or plurality of passages 14 for heating system fluid formed therein. The passages 14 are disposed about the cylinders 16 of the engine 12. The passages 14 communicate with a water pump 17 and fan 18 structure and with the return 19 to a radiator 21. A hose 22 disposed away from the return 19 extends between the radiator 21 and the passages 14 within the engine block 13. The heater core 23 is connected by hoses 24 to the passages 14.

As the engine 12 runs it heats up by itself to an operating temperature. Heating system fluid flows through the passages 14 over the heating engine 12 thus raising the temperature of the heating system fluid.

At the heater core 23, the heating system fluid passes through a series heater core tubes (not depicted) which are connected to heat transfer fins, thus raising the temperature of the heating core fins (not depicted). The heating core fins store and dissipate the heat. As air is blown over these heating core fins, heat is transferred from the fins to the blown air, which is then forced through tubes and vents into a passenger compartment of the automobile, thereby making the temperature with the passenger compartment comfortable.

All of this is known in the prior art.

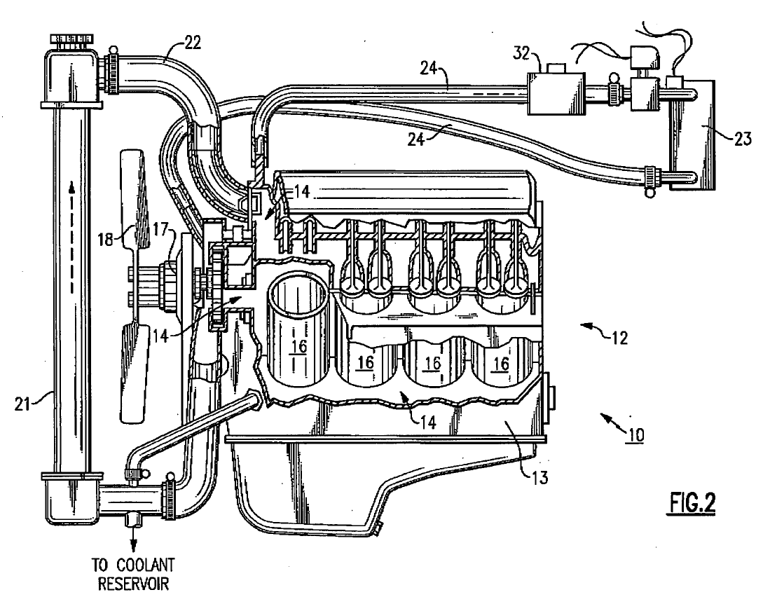

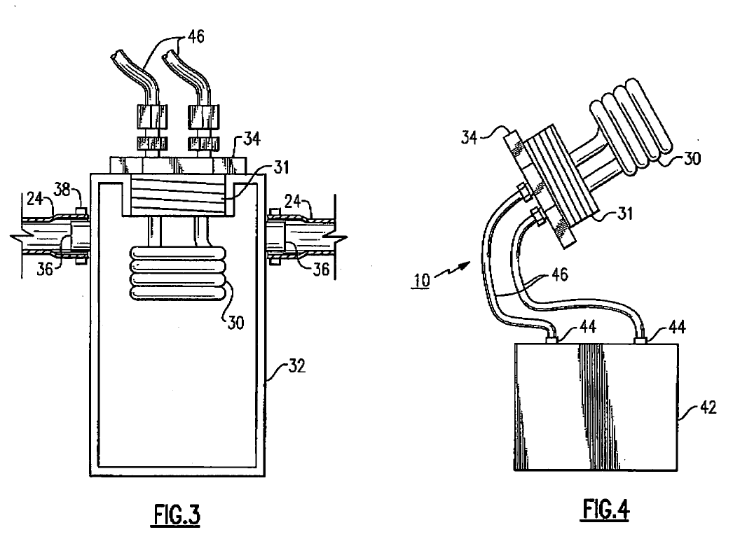

Turning now to the present invention, and referring to FIGS. 2-5, there is depicted a heating element 30 in accordance with a preferred embodiment of the present invention. The heating element 30 includes a threaded member 31 which threads within a housing 32. A locknut 34 allows a mechanic to tightly secure the heating element 30 within the housing 32 with the use of a wrench.

The housing 32 includes a pair of hose ports 36 each of which interrupt hose 24 at a point near the heater core 23, which is depicted in FIG. 2. The mechanic simply cuts the hose 24 and attaches each end to one of the hose ports 36 and secures hose 24 to port 36 with a hose clamp 38. The reason that it is desirable to have the housing 32 near the heater core 23 is that less heat is lost as the coolant travels a short distance from the housing 32 to the heater core 23, thus quickly raising the temperature of the heater core 23.

The heat from the heating element 30 also provides additional heat to the heating system fluid, thus helping to quickly raise the temperature of the engine 12 as the heating system fluid passes thereover.

The heating element 30 contains a tubular metallic member 40 having a high resistivity thus allowing the tubular metallic member 40 to attain high temperatures when connected across a twelve volt automobile battery 42, which is shown in FIG. 3. In a preferred embodiment, ten gauge braided wiring 46 is used to couple the tubular metallic member 40 across a pair of battery terminals 44. Typically, the automobile battery 42 produces 12 volts across its terminals 44 and the automobile alternator (not depicted) typically produces upwards of between sixty and one-hundred and forty amperes when running. The tubular metallic member 40 draws approximately 0.2 volts and between thirty to fifty five amperes.

In an alternative preferred embodiment depicted in FIG. 5, the housing 32 is simply a two inch outside diameter pipe 50 having an end cap 52 either threaded or welded onto one pipe end 54 thereof. As is readily apparent the shape of the housing is unimportant. The pipe 50 further includes a pair of ⅜″ ports 60 welded to a pair of openings 56 in a radial wall 58 of the pipe 50. These ports 60 transect the hose 24. Obviously various sizes will work efficiently as should be apparent to one skilled in the art.

It is desirable, but not necessary, that the heating element 30 take up a significant portion of an inner volume of the housing 32. As such, a greater percentage of the heating system fluid will be in contact with the heating element 30 as it passes through the housing 32. Thus, the temperature of the heating system fluid will be higher when it reaches the heater core 23.

At a pipe end 62 opposite to pipe end 54, a threaded cap 64 is secured to the pipe end 62 either by threading or welding thereto. The threaded cap 64 includes a threaded opening 66 therethrough that receives the threaded member 31 of the heating element 30. The tubular metallic member 40 has an approximate outside diameter of one quarter inch in the preferred embodiment.

When the engine 12 is started, the tubular metallic member 40 attains a temperature of approximately 300 degrees F. in less than one minute. This causes the coolant to achieve a similar temperature within the housing 32 which is disposed near the heater core 23. Thus, the heater core 23 realizes a higher temperature much quicker and the air into the passenger compartment is warm much quicker.

Once the engine 12 is up to operating temperature, a relay and temperature sensor (not depicted) opens the connection between the heating element 30 and the battery 42 thereby disabling the heating element. During engine shut-off another sensor and relay (not depicted) will open the connection between the heating element 30 and the battery 42 so that the heating element 30 does not draw down the capacity within the battery 42. Alternatively, a manual switch mounted into a passenger dashboard area may be used to connect the heating element 30 to the battery 42.

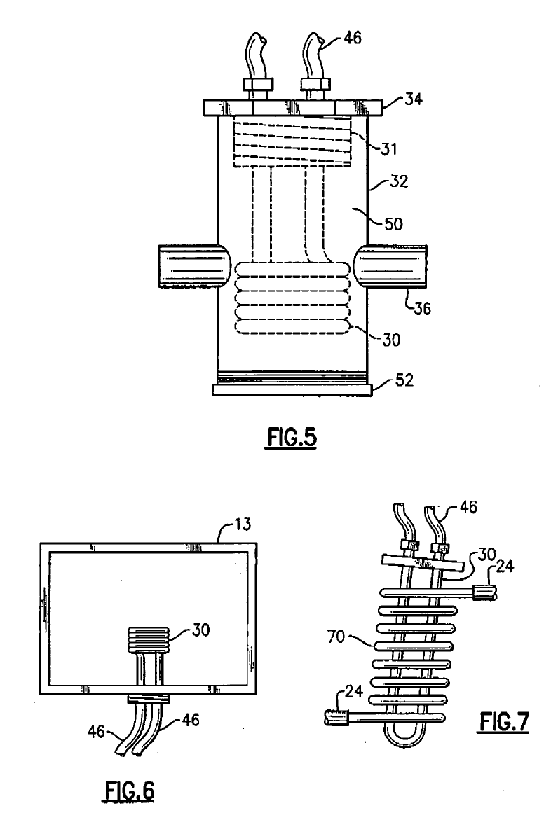

In alternative embodiments of the present invention, the heating element 30 may be disposed anywhere within the heating system 10 so that it directly or indirectly contacts the heating system fluid. For example, and as depicted in FIG. 6, the heating element 30 may be mounted within the engine block 13 so that the heating element 30 extends into a passage 14 to contact the heating system flowing therethrough.

Yet alternatively the heating element 30 may extend directly into the radiator 21, water pump 17, coolant reservoir (not depicted) or any other position within the heating system 10.

It is also not necessary that the heating element 30 be mounted within a housing at all. Referring now to FIG. 7, the heating element 30 is freely floating within a coiled tube 70 of heating system fluid. The heating element 30 heats the coiled tube 70 which in turn heats the heating system fluid.

Furthermore, the heating element 30 may take on various sizes and shapes. For example and referring still to Fig., the heating element 30 is substantially U-shaped.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

1-19. (canceled)

20. In a heat management system for an internal combustion engine, wherein a heating system fluid is cycled through the engine, and stores and dissipates heat in an internal combustion engine heat control system, and in which the heating system fluid flows to a passenger comfort heat exchanger heating core, and returns to the internal combustion engine, the heat management system and in which a heating system fluid pre-heater is disposed to heat the heating system fluid prior to its reaching the heating core, and with an electrically conductive heating element which contacts said heating system fluid; and with electrical connection means for connecting said electrically conductive heating element to an internal combustion electrical system that includes an engine battery; the improvement wherein said heating element has a current draw of 30 to 55 Amperes, and in that said connection means includes switching means for controlled making of the electrical connection of with said electrical system when the engine is started and controlled breaking of the connection when the engine has warmed up.

21. The heat management system of claim 20, wherein the heating system fluid heater includes a housing having an inlet opening for receiving heating system fluid therethrough from a first end of a transected heating system hose; an outlet opening for transmitting said heating system fluid through a second end of the transected heating system hose ; and with said electrically conductive heating element is disposed in an internal cavity of said housing.

22. The heat management system of claim 20, wherein said heating element is in the form of a metallic tubular heating coil.

23. The heat management system of claim 22, wherein said inlet opening includes a tubular port which extends from an exterior wall of said housing.

24. The heat management system of claim 21, wherein said outlet opening includes a tubular port which extends from an exterior wall of said housing.

25. The heat management system of claim 21, wherein said second end of said transected hose feeds an inlet opening to said heater core.

26. The heat management system of claim 21, wherein said housing is free of any flow restriction devices.

27. The heat management system of claim 20, wherein said heating element is disposed within one of an engine housing, a radiator housing, a heater core housing, a water pump housing, a heating system fluid reservoir housing and a heating system hose.

28. The heat management system of claim 20, wherein said heating element is externally connected in contact with a fluid conduit through which said heating system fluid flows.

29. The heating system fluid heater of claim 28, further characterized in that said fluid conduit includes at least one coiled tube containing said heating system fluid, and said at least one coiled tube is closely positioned to said heating element so that heat is transferred from said heating element to said at least one coiled tube.

30. A method of bringing an internal combustion motor vehicle engine up to an operating temperature, wherein said engine is liquid-cooled and has a heat management system that includes a jacket in contact with operating components of said engine and containing a heat management liquid, at least one heat exchanger for thermally contacting said heat management liquid with an air flow; a pump for circulating said heat management liquid, and a first hose carrying the fluid to said heat exchanger and a second hose returning the liquid from the heat exchanger to the engine; the improvement in which the method includes flowing the liquid in the first hose through a fluid preheating element, formed of a housing having ports in line with said hose, and containing, enclosed within the housing, an electric heating coil in contact with the liquid within the housing; supplying a DC current of 30 to 55 amperes from an engine electrical system for the internal combustion engine to said heating coil; and heating said heat management liquid flowing through said housing before supplying the liquid to said heat exchanger.

31. The method according to claim 30, wherein a timer shuts off said DC current to said heating coil at a predetermined delay time after said engine has been started.

32. The method according to claim 30, wherein a sensor in contact with said engine shuts off said DC current to said heating coil after said sensor detects that said engine has reached a predetermined operating temperature.

33. The heat management system of claim 20, comprising a thermostat which partially restricts flow of the heating system fluid at engine start-up.

34. The method according to claim 30, wherein a thermostat partially restricts flow of the liquid at engine start-up.
